(19) United States
(12) Patent Application Publication
(10) Pub. No.: US 2011/0043727 A1
(43) Pub. Date: Feb. 24, 2011

(54) ADHESIVE LAYER FOR MULTILAYER OPTICAL FILM

(75) Inventors: Ellen R. Bösl, Eagan, MN (US); Clinton L. Jones, Somerset, WI (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 12/935,407

(22) PCT Filed: Mar. 27, 2009
(86) PCT No.: PCT/US2009/038487

§ 371 Date: Sep. 29, 2010

Related U.S. Application Data
(60) Provisional application No. 61/041,092, filed on Mar. 31, 2008.
(60) Provisional application No. 61/159,312, filed on Mar. 11, 2009.

(51) Int. Cl. G02F 1/1333; B32B 27/36; B32B 3/00; B32B 27/12; B32B 27/34; B32B 27/38; B32B 37/12

(52) U.S. Cl. 349/84; 428/480; 428/336; 428/473.5; 428/475.2; 428/483; 428/412; 428/414; 428/335; 156/332

(57) ABSTRACT

Disclosed herein is an optical article including a multilayer optical film, a light transmissive support layer, and an adhesive layer disposed between the multilayer optical film and the light transmissive support layer. The adhesive layer includes an aromatic polyester (meth)acrylate oligomer and an aromatic ethylenically unsaturated monomer, wherein the total amount of the aromatic polyester (meth)acrylate oligomer and the aromatic ethylenically unsaturated monomer is at least about 90 wt. % of the adhesive layer. Also disclosed herein is a method of making the optical article and display devices including the optical article.

### FIELD OF THE INVENTION

This invention relates to coatings for optical films, and particularly to adhesive layers for multilayer optical films.

### BACKGROUND

Adhesive layers are often used to adhere support layers to multilayer optical films. The resulting optical articles are often used in display devices. For various reasons, the operating environment inside of a display device, such as a liquid crystal display television, can be rather extreme such that optical articles used in the device can be subjected to high heat and humidity, heat/UV exposure, and thermal shock. Failure of an adhesive layer due to these extreme conditions can cause warping, delamination, loss of stiffness, and discoloring of the optical article.

### SUMMARY

Disclosed herein is an optical article including a multilayer optical film, a light transmissive support layer, and an adhesive layer disposed between the multilayer optical film and the light transmissive support layer. The adhesive layer includes an aromatic polyester (meth)acrylate oligomer and an aromatic ethylenically unsaturated monomer, wherein the total amount of the aromatic polyester (meth)acrylate oligomer and the aromatic ethylenically unsaturated monomer is at least about 90 wt. % of the adhesive layer. Also disclosed herein is a method of making the optical article and display devices including the optical article.

These and other aspects of the invention are described in the detailed description below. In no event should the above summary be construed as a limitation on the claimed subject matter which is defined solely by the claims as set forth herein.

### BRIEF DESCRIPTION OF THE DRAWINGS

The invention may be more completely understood in consideration of the following detailed description in connection with the following figures:

FIGS. 1 and 2 show schematic cross sectional views of exemplary optical articles.

FIG. 3 is a graph showing elastic modulus versus temperature for several adhesives.

### DETAILED DESCRIPTION

Disclosed herein is an adhesive layer that may be used to facilitate adhesion between a multilayer optical film and a light transmissive support layer. For example, the adhesive layer is useful for adhering polyester-based multilayer optical films to light transmissive support layers such as polyethylene terephthalate (PET) and polycarbonate.

The adhesive layer disclosed herein may be used to provide a number of advantages. For example, the adhesive layer may be used to make optical articles that can be converted with little or no delamination of the article. This includes not only delamination at the interface between the adhesive layer and the multilayer optical film, but also within the multilayer optical film itself. Exemplary converting operations include slitting to obtain articles of a desired width, cross-cutting such as guillotining to obtain articles of a desired length, and die cutting, e.g., flatbed or rotary, to obtain articles of a desired shape. Other converting operations include perforating and punching.

The adhesive layer may also provide optical articles that exhibit little or no warping. i.e., remain dimensionally stable, during and after exposure to temperatures and temperature cycles, such as observed in an LCD-TV. When large-sized laminated optical articles are produced, the part tolerances must be substantially retained after exposure to elevated temperature for long periods of time or when exposed to temperature cycling.

The adhesive layer may also provide optical articles that exhibit preservation of stiffness across a wide range of environmental conditions that include prolonged exposure to high heat and humidity conditions such as 65° C./95 RH testing for 500 hours. Stiffness preservation is desirable to provide a dimensionally stable optical film laminate during the storage and use of the film and assembled LCD. Optical articles that have dimensional instabilities may create aesthetically undesirable images to the viewer of the LCD. When large-sized laminated optical articles are produced, the part tolerances must be substantially retained after exposure to elevated temperature for long periods of time or when exposed to temperature cycling.

The adhesive layer may also provide optical articles that exhibit little or no changes in color and/or little or no darkening effects. Significant changes in color of the optical film laminate may contribute to visible defects and unacceptable color, as determined by the viewer of the assembled LCD product. Historically, oligomeric materials employed as optical adhesives for DBEF laminates contain aliphatic oligomeric materials, typically with nitrogen-containing segments. Those skilled-in-the-art in developing optical adhesives would typically refrain from incorporating aromatic oligomers due to the concern that the aromatic oligomer would contribute to deleterious color development during environmental aging, in particular, the increase in yellow color shift resulting from accelerated QUV aging (test conditions described below).

The adhesive layer may also provide optical articles that exhibit acceptable hand peel adhesion to reduce the potential for delaminating during the converting process and during the useful lifetime of the optical film article.

The adhesive layer may also provide optical articles that exhibit an elastic tensile modulus of <1×10⁸ Pa at the converting temperature. Normal converting temperatures are between 15 and 30° C., although higher temperatures may be useful. Optical film articles with adhesive layers in the aforementioned elastic modulus range contribute to the reduced potential for delaminating during the converting process and during the useful lifetime of the optical film article.

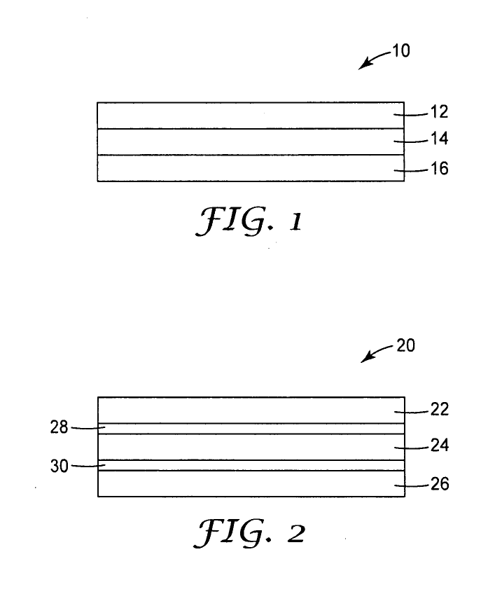

FIG. 1 shows a cross sectional view of an exemplary optical article disclosed herein. Optical article 10 comprises multilayer optical film 12 comprising a plurality of alternating layers of first and second optical layers (not shown), light transmissive substrate 16, and adhesive layer 14 disposed between the multilayer optical film and the light transmissive substrate. The adhesive layer can have any suitable thickness provided it can provide the desired properties. In some embodiments, the thickness is from about 5 to about 40 um.

The adhesive layer comprises an aromatic polyester (meth)acrylate oligomer, wherein the oligomer has at least one hydroxyl group on the main chain of the oligomer, and an aromatic ethylenically unsaturated monomer, wherein the total amount of the aromatic polyester (meth)acrylate oligomer and the aromatic ethylenically unsaturated monomer comprises at least about 90 wt. % of the adhesive layer. As used herein, the term polyester refers to polyesters made from a single dicarboxylate monomer and a single diol monomer and also to copolyesters which are made from more than one dicarboxylate monomer and/or more than one diol monomer. In general, polyesters are prepared by condensation of the carboxylate groups of the dicarboxylate monomer with hydroxyl groups of the diol monomer. As used herein, the terms “dicarboxylate” and “dicarboxylic acid” are used interchangeably.

The adhesive layer comprises a polyester comprising one or more dicarboxylic acids and one or more diols. Useful dicarboxylic acids include aromatic dicarboxylic acids such as naphthalene dicarboxylic acid; terephthalate dicarboxylic acid; phthalate dicarboxylic acid; isophthalate dicarboxylic acid; t-butyl isophthalic acid; tri-mellitic acid; 4,4′-biphenyl dicarboxylic acid; and combinations thereof. Useful dicarboxylic acids include aliphatic dicarboxylic acids such as (meth)acrylic acid; maleic acid; itaconic acid; azelaic acid; adipic acid; sebacic acid; norbornene dicarboxylic acid; bi-cyclooctane dicarboxylic acid; 1,6-cyclohexane dicarboxylic acid; and combinations thereof. Any of the aforementioned dicarboxylic acids may be used in their dicarboxylate forms, i.e., as salts, or they may be mono- or diesters of aliphatic groups having from 1 to 10 carbon atoms.

Useful diols include diol monomers include those having more than two hydroxyl groups, for example, triols, tetraols, and pentaols, may also be useful. Useful aromatic diols include 1,4-benzenedimethanol; bisphenol A; ring-opened bisphenol A diglycidal ether, 1,3-bis(2-hydroxyethoxy)benzene; and combinations thereof. Useful aliphatic diols include 1,6-hexanediol; 1,4-butanediol; trimethylolpropane; 1,4-cyclohexanedimethanol; neopentyl glycol; ethylene glycol; propylene glycol; polyethylene glycol; tricyclodecanediol; norbornane diol; bicyclo-octanediol; pentaerythritol; and combinations thereof.

The adhesive layer also comprises a diluent comprises one or more monomers. In general, the diluent is free-radically polymerizable and may comprise an aromatic ethylenically unsaturated monomer. Examples include (meth)acrylates such as alkyl esters of (meth)acrylic acid wherein the alkyl group has from 1 to 20 carbon atoms, for example, ethyl acrylate, isobornyl methacrylate, and lauryl methacrylate. Examples of (meth)acrylates include aromatic esters of (meth)acrylic acid such as benzyl methacrylate, phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2,4-dibromophenoxyethyl (meth)acrylate, 2,4,6-tribromophenoxyethyl (meth)acrylate, 4,6-dibromo-2-alkyl phenyl (meth)acrylate, 2,6-dibromo-4-alkyl phenyl (meth)acrylate, 2-(1-naphthyloxy)ethyl (meth)acrylate, 2-(2-naphthyloxy)ethyl (meth)acrylate, 2-(1-naphthylthio)ethyl (meth)acrylate, 2-(2-naphthylthio)ethyl (meth)acrylate, and combinations thereof. As used herein, (meth)acrylate refers to both acrylates and methacrylates. Examples of vinyl monomers include vinyl esters such as vinyl acetate, styrene and derivatives thereof, vinyl halides, vinyl propionates, and mixtures thereof.

The weight ratio of aromatic polyester (meth)acrylate oligomer to aromatic ethylenically unsaturated monomer is from about 30:70 to about 50:50.

The adhesive layer is typically prepared by free radical polymerization of an adhesive composition comprising an aromatic polyester (meth)acrylate oligomer and an aromatic ethylenically unsaturated monomer. There is often an initiator included in the polymerizable composition. The initiator can be a thermal initiator, a photoinitiator, or both. Examples of initiators include organic peroxides, azo compounds, quinines, nitro compounds, acyl halides, hydrazones, mercapto compounds, pyrylium compounds, imidazoles, chlorotriazines, benzoin, benzoin alkyl ethers, di-ketones, phenones, and the like. Commerically available photoinitiators include, but are not limited to, 2-hydroxy-2-methyl-1-phenyl-propane-1-one (e.g., commercially available as DAROCUR 1173 from Ciba Specialty Chemicals), a mixture of 2,4,6-trimethylbenzoyl-diphenyl-phosphine oxide and 2-hydroxy-2-methyl-1-phenyl-propan-1-one (e.g., commercially available as DARACUR 4265 from Ciba Specialty Chemicals), 2,2-dimethoxy-1,2-diphenylethan-1-one (e.g., commercially available as IRGACURE 651 from Ciba Specialty Chemicals), a mixture of bis(2,6-dimethoxybenzoyl)-2,4,4-trimethyl-pentylphosphine oxide and 1-hydroxy-cyclohexyl-phenyl-ketone (e.g., commercially available as IRGACURE 1800 from Ciba Specialty Chemicals), a mixture of bis(2,6-diemethoxybenzoyl)-2,4,4-trimethyl-pentylphosphine oxide (e.g., commercially available as IRGACURE 1700 from Ciba Specialty Chemicals), 2-methyl-1[4-(methylthio)phenyl]-2-morpholinopropan-1-one (e.g., commercially available as IRGACURE 907 from Ciba Specialty Chemicals), and bis(2,4,6-trimethylbenzoyl)-phenylphosphine oxide (e.g., commercially available as IRGACURE 819 from Ciba Specialty Chemicals), ethyl 2,4,6-trimethylbenzoyldiphenyl phosphinate (e.g., commercially available from BASF, Charlotte, N.C. as LUCIRIN TPO-L), and 2,4,6-trimethylbenzoyldiphenylphosphine oxide (e.g., commercially available from BASF, Charlotte, N.C. as LUCIRIN TPO). The photoinitiator is often used at a concentration of about 0.1 to 10 weight percent or 0.1 to 5 weight percent based on the weight of oligomeric and monomer material in the polymerizable composition.

The adhesive layer and coating composition may contain other types of additives. Preferably, such materials should be compatible with the primary components of the coating and coating formulation, and should not adversely affect performance attributes of the optical article. These include coating aids such as surfactants and coalescing solvents; UV absorbers; hindered amine light stabilizers; defoaming agents; particulates used as, for instance, slip agents; antioxidants; and pH control agents such as buffers or trialkylamines.

Also disclosed herein is a method of making the optical article. The method may comprise a continuous process such as a roll-to-roll process in which the adhesive composition is applied between the multilayer layer optical film and the light transmissive substrate as they are being fed concurrently with some fixed intervening gap.

The method may also comprise coating the adhesive composition described above onto either the multilayer optical film or the light transmissive substrate, thereby forming a coated article. Any of a variety of coating techniques may be used; example include dip, roll, die, knife, air knife, slot, slide, wire wound rod, and curtain coating. A comprehensive discussion of coating techniques can be found in Cohen, E. and Gutoff, E. Modern Coating and Drying Technology; VCH Publishers: New York, 1992; p. 122; and in Tricot, Y-M. Surfactants: Static and Dynamic Surface Tension. In Liquid Film Coating; Kistler, S. F. and Schweizer, P. M., Eds.; Chapman & Hall: London, 1997; p. 99.

The adhesive composition can be cured using UV radiation or any other suitable curing technique. For example, if it is desirable to use heat to cure the composition, then a thermal initiator may be used in place of the photoinitiator.

The multilayer optical film may comprise any of a variety of materials including polyesters such as polyethylene terephthalate, polyethylene naphthalate, copolyesters or polyester blends based on naphthalene dicarboxylic acids; polycarbonates; polystyrenes; styrene-acrylonitriles; cellulose acetates; polyether sulfones; poly(meth)acrylates such as polymethylmethacrylate; polyurethanes; polyvinyl chloride; polycyclo-olefins; polyimides; glass; paper; or combinations or blends thereof. Particular examples include polyethylene terephthalate, polymethyl methacrylate, polyvinyl chloride, and cellulose triacetate. Preferable examples include polyethylene terephthalate, polyethylene naphthalate, cellulose triacetate, polypropylene, polyester, polycarbonate, polymethylmethacrylate, polyimide, polyamide, or a blend thereof. Preferably, the multilayer optical film is sufficiently resistant to temperature and aging such that performance of the article is not compromised over time. The thickness of the multilayer optical film is typically less than about 2.5 mm. The multilayer optical film may also be an orientable film such as a cast web substrate that is coated before orientation in a tentering operation.

The multilayer optical film is suitable for use in optical applications. Useful multilayer optical films are designed to control the flow of light. They may have a transmission of greater than about 90%, and a haze value of less than about 5%, for example, less than 2%, or less than 1%. Properties to consider when selecting a suitable multilayer optical film include mechanical properties such as flexibility, dimensional stability, self-supportability, and impact resistance. For example, the multilayer optical film may need to be structurally strong enough so that the article can be assembled as part of a display device.

The multilayer optical film may be used in a wide variety of applications such as graphic arts and optical applications. A useful multilayer optical film may be described as a reflective film, a polarizer film, a reflective polarizer film, a diffuse blend reflective polarizer film, a diffuser film, a brightness enhancing film, a turning film, a mirror film, or a combination thereof. The multilayer optical film may have ten or less layers, hundreds, or even thousands of layers, the layers being composed of some combination of all birefringent optical layers, some birefringent optical layers, or all isotropic optical layers. In one embodiment, the multilayer optical film has alternating layers of first and second optical layers, wherein the first and second optical layers have refractive indices along at least one axis that differ by at least 0.04. Multilayer optical films having refractive index mismatches are described in the references cited below. In another embodiment, the multilayer optical film may comprise one or more layers of any of the above multilayer optical films such that the primer layer is buried in any one of them, making the article itself a reflective film, a polarizer film, a reflective polarizer film, a diffuse blend reflective polarizer film, a diffuser film, a brightness enhancing film, a turning film, a mirror film, or a combination thereof.

Useful multilayer optical films include commercially available optical films marketed as Vikuiti™ Dual Brightness Enhanced Film (DBEF), Vikuiti™ Brightness Enhanced Film (BEF), Vikuiti™ Diffuse Reflective Polarizer Film (DRPF), Vikuiti™ Enhanced Specular Reflector (ESR), and Vikuiti™ Advanced Polarizing Film (APF), all available from 3M Company. Useful optical films are also described in U.S. Pat. Nos. 5,825,543; 5,828,488 (Ouderkirk et al.); 5,867,316; 5,882,774; 6,179,948 B1 (Merrill et al.); 6,352,761 B1; 6,368,699 B1; 6,927,900 B2; 6,827,886 (Neavin et al.); 6,972,813 B1 (Toyooka); 6,991,695; 2006/0084780 A1 (Hebrink et al.); 2006/0216524 A1; 2006/0226561 A1 (Merrill et al.); 2007/0047080 A1 (Stover et al.); WO 95/17303; WO 95/17691; WO95/17692; WO 95/17699; WO 96/19347; WO 97/01440; WO 99/36248; and WO99/36262. These multilayer optical films are merely illustrative and are not meant to be an exhaustive list of suitable multilayer optical films that can be used. In some of these embodiments, the primer layer of this invention may be an internal layer in a multilayer film construction.

Examples of substrates include any of those useful in optical applications such as polyester, polycarbonate, poly(meth)acrylates, any of which may or may not be oriented.

In some embodiments, the light transmissive substrate comprises the stretched polyester film described in commonly assigned U.S. Provisional Ser. No. 61/041,112 (Bosl et al.).

FIG. 2 shows a cross sectional view of another exemplary optical article disclosed herein. Optical article 20 comprises multilayer optical film 24 comprising a plurality of alternating layers of first and second optical layers (not shown). Light transmissive substrates 22 and 26 are disposed on each side of the multilayer optical film, and adhesive layers 28 and 30 are disposed between the multilayer optical film and each light transmissive substrate. In some embodiments, this optical article may have the constructions as described in commonly assigned U.S. Provisional Ser. No. 61/040,910 (Derks et al.).

The optical article may be used in a graphic arts application, for example, in backlit signs, billboards, and the like. The optical article may also be used in a display device comprising, at the very least, one or more light sources and a display panel. The display panel may be of any type capable of producing images, graphics, text, etc., and may be mono- or polychromatic, or transmissive or reflective. Examples include a liquid crystal display panel, a plasma display panel, or a touch screen. The light sources may comprise fluorescent lamps, phosphorescent lights, light emitting diodes, or combinations thereof. Examples of display devices include televisions, monitors, laptop computers, and handheld devices such as cell phones, PDAs, calculators, and the like.

The invention may be more completely understood in consideration of the following examples.

### EXAMPLES

### Test Methods

### Edge Delamination

The Edge Delamination Rating is determined by converting at nominally 25° C. the optical film laminate using a steel rule die punch common in the optical film industry. Typical steel rule dies may have a diagonal size of up to 65 inches and typically include two or more tabs and/or hole configurations of various design.

After the laminate is converted, the part is visually inspected for delamination which may be observed as a decrease in transparency in areas adjacent to the edge of the part, tab or holes. If delamination is observed, the length of the delamination in the direction orthogonal to the edge is recorded. A part should have no edge delamination that exceeds 1 mm to obtain a pass rating. For each laminate, the percentage of parts with acceptable edge delamination is recorded in Table 4 and is calculated using the following equation:

Edge Delamination % pass=[(number of parts with edge delamination<1 mm)/(total number of parts)]×100

It is preferred to have an Edge Delamination % pass value of 100%.

### Warp Test

One example of observing dimensional stability in laminates is as follows: Clean two 24.1 cm×31.8 cm pieces of double-strength glass using isopropyl alcohol to remove any dust. Attach a 22.9 cm×30.5 cm piece of laminate film to one piece of the glass on the two short sides and one of the long sides, leaving the remaining long side unconstrained. The laminate film can be attached to the glass using 3M™ double-coated tape 9690 (3M, St. Paul, Minn.) such that the tape is 1.3 cm from the three edges of the glass that will be covered by the three sides of the laminate film. The laminate film is attached to the tape so that it is held above the glass surface by the thickness of the tape (about 0.14 mm). The laminate is adhered to the tape using a 2 kg roller, passing the roller over each tape side one time in each direction. Equivalent thickness and lengths of 1.3-cm wide PET film shim stock are next placed onto the opposite side of the laminate and centered over the tape. The second piece of glass is placed on top of the shims and is exactly aligned with the bottom piece of glass. This completes the sandwiched test module of glass-tape-laminate film-shim-glass, in which the laminate film is constrained at three edges and substantially free-floating in the center. This module is attached together using four binder clips, as are commonly used to hold stacks of paper together (Binder Clips, Officemate International Corporation, Edison, N.J.). The clips should be of an appropriate size to apply pressure to the center of the tape approximately 1.9 cm from the edge of the glass. The binder clips are positioned two each on the short sides of the module, each about 1.9 cm from the top edge of the laminate film held between the glass plates of the module.

The completed glass plate module is placed in a thermal shock chamber (Model SV4-2-2-15 Environmental Test Chamber, Envirotronics, Inc., Grand Rapids, Mich.) and is subjected to 84 temperature cycles. Each temperature cycle includes cooling the module to −35° C., followed by holding at that temperature for one hour and then increasing the oven temperature in a single step to 85° C., followed by holding at that temperature for one hour. Following the temperature cycling, the laminate film is then removed from the module and inspected for wrinkles using a surface mapping technique which calculates an average slope of the wrinkles Lower average slope numbers indicate less warping or wrinkling which is a desirable film attribute. Preferred average slope values are less than 0.15.

### Light Stability

Each of the laminated articles described below were tested using a QUVcw light exposure apparatus equipped with Phillips F40 50 U bulbs, which have an emission spectrum similar to the cold cathode fluorescent lamps found in typical LCD-TVs. The intensity of the emission was adjusted to be 0.5 W/m² at 448 nm, which resulted in a UV intensity of 1.71 W/m² integrated over 340-400 nm. The chamber temperature during the exposure was 83° C. and the length of the exposure was 12 days.

Degradation of the optical laminate construction can be determined by measuring the shift in color corrdinates as calculated by the DELTA.E value. The DELTA.E value is derived from the individual value shifts of the L*, a*, and b* coordinates defined by the CIE L*a*b* color space, developed by the Commission Internationale de l'Eclairage in 1976. A widely used method for measuring and ordering color, CIE L*a*b* color space is a three-dimensional space in which a color is defined as a location in the space using the terms L*, a*, and b*. L* is a measure of the lightness of a color and ranges from zero (black) to 100 (white) and may be visualized as the z-axis of a typical three-dimensional plot having x-, y-, and z-axes. The terms a* and b* define the hue and chroma of a color and may be visualized as the x- and y-axes, respectively. The term a* ranges from a negative number (green) to a positive number (red), and the term b* ranges from a negative number (blue) to a positive number (yellow). For a complete description of color measurement, see “Measuring Color”, 2nd Edition by R. W. G. Hunt, published by Ellis Horwood Ltd., 1991. In general, DELTA.E for the optical film laminate should be less than 3.0, preferably less than 2.0, to meet industry expectations for color shift. DELTA.E is calculated using the following equation:

DELTA.E=[(L_{f}*−Lᵢ*)²+(a_{f}*−aᵢ*)²+(b_{f}*−bᵢ*)²]^{1/2}

where subscript f indicates final value and subscript i indicates initial value.

### Stiffness Preservation

The stiffness of the laminates were determined on an INSTRON 3342 equipped with a 50N load cell and a 3-point bending fixture. Samples strips 25 mm wide were cut from a larger master laminate. The crosshead speed was 0.5 mm/min. Force was applied to the sample via the traveling 5 crosshead, and the sample was contacted with an anvil having a 10 mm diameter. The two lower support anvils had a diameter of 3.94 mm each, and the center-to-center distance of these support anvils was 8.81 mm. Values are measured in N/mm based on the change in force N divided by the crosshead travel distance in mm for given change in force.

Multiple sample strips were cut from the same laminate. Three samples were tested without environmental aging and the averages of the values were reported as initial stiffness. From the same laminate, an additional three samples were placed into 65° C. test chambers at 95% relative humidity for 500 hours and the averages of the values recorded. For each laminate, the value of % Stiffness Preservation is reported in Table 4 and was calculated by the following equation:

% Stiffness Preservation=[S_{f}/Sᵢ]×100

where S_{f} is the stiffness value after aging sample for 500 hours and Sᵢ is the initial stiffness. Preferred % Stiffness Preservation values are >/=100%, indicating no loss of stiffness after high heat and humidity testing.

### Hand Peel Adhesion

Optical film laminate samples were peeled apart by hand and evaluated for adhesion. In order to peel apart a laminate, a crease was formed at the edge of the sample.

The optical film construction delaminates in the creased area and the resulting delaminated substrates are physically separated by hand along the length of the sample. The delamination interfaces are subsequently inspected for using Criteria 1 and Criteria 2 as described in Table 1.

TABLE 1

| | | Criteria 1 | Criteria 2 |
|---|---|---|---|
| | | Delamination | Delamination at the interface |
| Rating | Definition | within MOF | between MOF and adhesive |
| G | good | Y | N |
| NG | no good | N | Y |

### Elastic Modulus

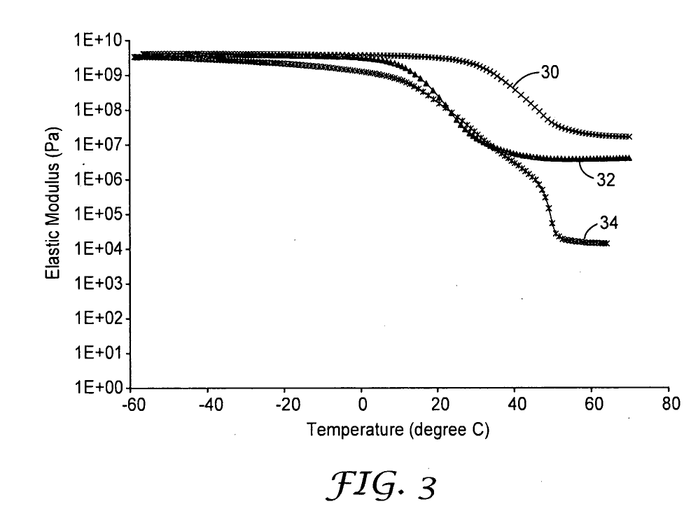

Elastic tensile modulus was measured according to ASTM D5026-01 over a range of temperatures from −60° C. to 70° C. The elastic tensile modulus was measured on freestanding adhesive samples produced by casting adhesive between two release liners. Adhesive was applied between two unprimed PET films and pulled through a fixed gap coater with a nominal setting of 10 mils. The PET and adhesive construction was passed at 50 fpm under two focused high intensity 600 W/in “D-bulb” UV lights powered by Fusion UV Systems, Inc. Both pieces of unprimed PET were removed prior to testing elastic modulus on the adhesive samples. Results are reported in Table 4 and shown in FIG. 3. In FIG. 3, elastic modulus versus temperature is shown for AC-4 (30), AC-1 (32), and AC-6 (34).

### Sn Content of the Adhesive Compositions

The samples were prepared via 2 different methods for the elemental analysis. The first was a traditional wet ash analysis, and the second was a strong acid leach of the sample (EPA Method 3050B).

Wet Ash: 0.5 grams of sample was accurately weighed into a quartz beaker. 4 mL H₂SO₄ was added and the beaker placed on a hotplate in the fume hood with a quartz watch glass. The temperature was slowly increased to thoroughly ash the material. Once the refluxing liquid was clear and colorless, 2 mL HNO₃ was added (in 0.5 mL increments) and the reaction proceeded until the reflux was again colorless. The volume was reduced to ˜1 mL. The temperature was decreased, then 2 mL H₂O₂ was added to complete the digestion and to expel any remaining HNO₃. 2 mL H₂SO₄ was added again, and the temperature increased to the emergence of white fumes. The temperature was decreased and the contents quantitatively transferred to a centrifuge tube and diluted to 25 mL with DI H₂O. Each sample was similarly prepared in duplicate with blanks.
EPA 3050B: 0.5 grams was accurately weighed into a polypropylene digestion tube. 10 mL of 1:1 HNO₃:H₂O was added, the tubes placed in the digestion block (preheated to 95 C) for 15 minutes. The tubes were removed from the block, allowed to cool, 1.5 mL of HNO₃ was added, and the tubes placed back in the block with polypro watch glasses. After 30 minutes another 1.5 mL HNO₃ was added, and the tubes heated for another 30 minutes. The tubes were removed from the block, cooled, and 1.0 mL H₂O₂ was added. The tubes were placed back in the block for 15 minutes. This was repeated twice more for a total of 3 mL H₂O₂. The tubes were removed from the block, cooled, and brought up to 25 mL with DI H₂O. The solution was passed through a syringe filter to remove residual solids. Each sample was similarly prepared in duplicate.

All solutions were analyzed on the PE Optima 3300 ICP-AES in axial mode. The analytes were calibrated against standards prepared at 0, 0.2, 0.5, and 1.0 ppm (mg/L). A separate 0.5-ppm check standard was analyzed periodically during the run to monitor calibration accuracy. A dilute solution of Sc was pumped in-line with all samples and standards to serve as an internal standard.

### Halogen Content Analysis of the Adhesive Compositions

### Procedure:

The sample was combusted in a COSA Instruments AQF-100 furnace. The accurately weighed samples (˜8-50 mg, weighed to ±1 μg) were presented to the furnace in ceramic boats. Each boat was directed through the AQF-100 by the ASC-120S solids autosampler module. The combustion chamber was kept at a constant high humidity by the WS-100 module. The gases evolved from the combustion were absorbed into an absorber solution in the GA-100 module. The absorber solution was directly injected into a Dionex ICS-2000 ion chromatograph. Blank combustions (no sample) were followed through the entire procedure. Calibration of the system was accomplished by isopropanolic solutions of fluoro-, chloro-, and bromo-benzoic acids and thiophenecarboxylic acid to the furnace inlet (in varying volumes).

### Conditions:

Furnace ABC program: 165/60; 185/120; 220/90; 180; 60; 10; 0; 300
   WS-100 flow rate: 3
   Inlet temp: 800° C., Outlet temp: 925° C.
GA-100 Absorber solution: 1 ppm phosphorus IS, 10 mL
   Injection loop: 100 μL
ICS-2000 Eluent: 30 mM KOH isocratic (EG40), 1.0 mL/min
   Columns: AG11HC (guard), AS11HC (analytical)
   Other: ASRS II Ultra suppressor, conductivity detection
      Results: Samples were measured in triplicate.

### Materials

Commercially available materials are described in Table 2 and were used as received.

TABLE 2

| Abreviation | Product Literature |
|---|---|
| CN2254 | aromatic polyester diacrylate (oligomer) |
| | CN2254 or PRO11020 (low Sn, low MeHQ) both from Sartomer |
| CN2003A | aromatic polyester diacrylate oligomer from Sartomer |
| CN2261 | aromatic polyester tetraacrylate oligomer from Sartomer |
| CN2256 | linear polyester diacrylate oligomer from Sartomer |
| CN991 | aliphatic urethane diacrylate oligomer from Sartomer |
| CN120 | epoxy diacrylate from Sartomer (oligomer) |
| EB8402 | aliphatic urethane diacrylate oligomer from UCB Chemicals |
| PHOTOMER | aliphatic urethane diacrylate from Cognis, Germany (oligomer) |
| 6010 | |
| PHOTOMER | aliphatic urethane diacrylate from Cognis, Germany (oligomer) |
| 6210 | |
| PHOTOMER | aliphatic urethane diacrylate from Cognis, Germany (oligomer) |
| 6891 | |
| SR 256 | 2(2-ethoxyethoxy)ethyl acrylate (aliphatic monofunctional |
| | diluent) from Sartomer |
| SR351 | trimethylolpropane triacrylate from Sartomer (aliphatic |
| | trifunctional diluent) |
| SR602 | ethoxylated (10) bisphenol A diacrylate from Sartomer |
| | (oligomer) |
| SR502 | ethoxylated (9) trimethylolpropane triacrylate from Sartomer |
| | (aliphatic trifunctional oligomer) |
| SR506 | isobornyl acrylate (aliphatic monofunctional diluent) from |
| | Sartomer |
| UA | proprietary aliphatic urethane acrylate resin (adhesive) |
| PEA | phenoxy ethyl acrylate(aromatic monofunctional diluent) |
| | SR339 from Sartomer or ETERNAL PEA from Eternal, Taiwan |
| 2-EHA | 2-ethyl hexyl acrylate (aliphatic monofunctional diluent) from 3M Co. |
| TPO | 2,4,6-trimethylbenzoyldiphenylphosphine oxide from Ciba, |
| | Switzerland (initiator) |
| TINUVIN 928 | 2-(2H-benzotriazol-2-yl)-6-(1-methyl-1-phenylethyl)-4-(1,1,3,3- |
| | tetramethylbutyl)phenol from Ciba, Switzerland (UV absorber) |
| TINUVIN 123 | decanedioic acid, bis(2,2,6,6-tetramethyl-1-(octyloxy)-4- |
| | piperidinyl) ester, reaction products with 1,1- |
| | dimethylethylhydroperoxide and octane from Ciba, Switzerland |
| | (hindered amine light stabilizer) |

### Adhesive Compositions

Adhesive compositions were prepared as described in Table 3. All compositions contained small amounts of TPO, TINUVIN 928, and/or TINUVIN 123 at less than about 3 wt. % of the composition.

TABLE 3

| Adhesive | Oligomer | Acrylate | Diluent |
|---|---|---|---|
| Composition | (wt. %) | Oligomer Type | (wt. %) |
| AC-1 | CN2254 (40) | aromatic polyester | PEA (60) |
| AC-2 | CN2003A (40) | aromatic polyester | PEA (60) |
| AC-3 | CN2261 (40) | aromatic polyester | PEA (60) |
| AC-4 | CN120 (40-50) | epoxy | PEA (50-60) |
| AC-5 | PHOTOMER | urethane | PEA (50) |
| | 6010 (50) | | |
| AC-6 | UA (100) | urethane | none |
| AC-7 | CN2254/ | aromatic polyester/epoxy | PEA (50) |
| | CN120 (25/25) | | |
| AC-8 | CN2254 (2.5) | aromatic | PEA (30) |
| | SR602 (55) | polyester/ethoxylated | |
| | SR502 (12.5) | bisphenol A | |
| AC-9 | CN2256 (40) | Linear polyester | PEA (60) |

### EXAMPLES

The laminated article as shown in FIG. 2 was prepared by concurrently coating two layers of adhesive (28 and 30) between three film layers (between 22 and 24 and between 24 and 26) using a gap coater with the gap set at 15 um for each adhesive layer.

Layer 24 comprised the multilayer optical film, a reflective polarizer, as described in commonly assigned U.S. Provisional Ser. No. 61/040,910 (Derks et al.) and having a nominal thickness of 33 um and outer skin layers comprised of PETG was employed as the multilayer optical film (i.e., 24 of FIG. 2).

Layer 22 comprised stretched PET described in commonly assigned U.S. Provisional Ser. No. 61/041,112 (Bosl et al.) and having a nominal thickness of 142 um. A gain diffuser coating having approximately 8 um diameter beads in an acrylate binder was present on the top surface of layer 22, the top surface being opposite adhesive layer 28. Layer 26 comprised stretched PET described in commonly assigned US Provisional Ser. No. 61/041,112 (Bosl et al.) and having a nominal thickness of 131 um. The stretch axes of layers 22 and 26 were aligned with the block axis of reflective polarizer 24.

The adhesive coated films were substantially fully cured in two steps with UV light exposure. A VPS600 UV curing system obtained from Fusion UV Systems was used. In the first curing step, low intensity cure was carried out for 20 seconds under low intensity light (<380 nm peak bulbs) with nominal intensity of 26.2 mW/cm² and a nominal dosage of 151-260 mJ/cm². In the second curing step, high intensity cure was carried out for 10 seconds under high intensity UV light with nominal intensity of 571 mW/cm² and a nominal dosage of 855 mJ/cm².

The resulting laminates were tested as described above. Results are shown in Table 4.

TABLE 4

| | | Edge | Warp Test | Light | | | Elastic |
|---|---|---|---|---|---|---|---|
| | Adhesive | Delam. | Average | Stability | Stiffness | Hand Peel | Modulus at 25 C. |
| Ex. | Composition | (% pass) | Slope | (ΔE) | Pres. (%) | Adhesion | (×10⁸ Pa) |
| 1 | AC-1 | 100¹ | 0.0063 | 0.625 | 103 | G¹ | 0.52 |
| 2 | AC-2 | NM | 0.0029 | 0.431 | 95 | G | NM |
| 3 | AC-3 | NM | 0.0039 | 0.681 | 98 | G | NM |
| 4³ | AC-1 | NM | 0.0043 | 0.665 | 95 | G | 0.52 |
| C1 | AC-4 | 0² | 0.0068² | 0.705² | 104² | G² | 35.10 |
| C2 | AC-5 | NM | 0.0056 | 3.1 | 93 | G | NM |
| C3 | AC-6 | 100 | 0.0035 | 0.58 | 82 | G | 0.62 |
| C4 | AC-7 | NM | 0.0031 | 1.0949 | 93 | NG | 14.85 |
| C5 | AC-8 | NM | 0.0029 | 2.1179 | 115 | NG | 0.25 |
| C6 | AC-9 | NM | 0.0034 | 2.1088 | 43 | G | NM |

¹skin layer contained about 0.3 wt. % PETg-i5
²diluent contained about 1 wt. % of SR351
³polycarbonate substrate (130 um) in place of polyester layers

Good hand peel adhesion was obtained for adhesive compositions comprising between 30:70 and 50:50 of CN2254:PEA and where the total weight of CN2254 and PEA was >90%. Good hand peel adhesion was also observed with 40:60 CN2254:PEA on different skin layers.

TABLE 5

| | | | | | | | Wt % |
|---|---|---|---|---|---|---|---|
| | Wt % | Wt % | Wt % | TPO | Tinuvin | Hand Peel | CN2254 |
| Ex. | CN2254 | PEA | CN120 | (pph) | 928 (pph) | Adhesion | and PEA |
| 5 | 30 | 70 | 0 | 1 | 1 | G | 98% |
| 6 | 37.5 | 62.5 | 0 | 1 | 1 | G | 98% |
| 7 | 40 | 60 | 0 | 1 | 1 | G | 98% |
| 8 | 45 | 55 | 0 | 1 | 1 | G | 98% |
| 9 | 50 | 50 | 0 | 1 | 1 | G | 98% |
| 10 | 30 | 65 | 5 | 1 | 1 | G | 93% |
| C7 | 34.375 | 56.875 | 8.75 | 1 | 1 | NG | 89% |
| C8 | 39.375 | 44.375 | 16.25 | 1 | 1 | NG | 82% |
| C9 | 40 | 40 | 20 | 1 | 1 | NG | 78% |

Uncured adhesive compositions were submitted for tin content, and halogen content analysis. Results are shown in Table 6.

| Adhesive | | | Total F | Total Cl | Total Br |
|---|---|---|---|---|---|
| Composition | Oligomer type | Sn (ppm) | (ppm) | (ppm) | (ppm) |
| AC-1 | Aromatic polyester | 6.58 +/− 0.25 | <0.5 | 236 +/− 5 | <0.5 |
| | acrylate | | | | |
| AC-2 | Aromatic polyester | 8.88 +/− 1.00 | <0.5 | 234 +/− 4 | <0.5 |
| | acrylate | | | | |
| AC-3 | Aromatic polyester | 96.32 +/− 4.52 | <0.5 | 232 +/− 2 | <0.5 |
| | acrylate | | | | |
| AC-4 | Epoxy acrylate | NM | 1.3 ± 0.5 | 764 +/− 15 | <0.5 |
| AC-6 | Urethane acrylate | 41.52 +/− 2.57 | NM | NM | NM |
| AC-7 | Polyester and epoxy | NM | 1.1 ± 0.5 | 608 +/− 12 | 2 +/− 1 |
| | acrylate blend | | | | |

Additional examples of formulations that did not show acceptable hand peel adhesion results are included below in Table 7. Formulations were made using commercially available materials described in Table 2 and were used as received. All compositions listed in Table 7 are in wt. % and all included 1 pph Tinuvin 928 and 1 pph TPO. Laminates were prepared per the description above. All laminates were made with an MOF with 75:25 50-50HH:PETg skins, except for those noted.

TABLE 7

| | CN | SR | CN | Photomer | CN | Photomer | Photomer | EB | | SR | 2- | SR | SR | SR | MOF |
|---|---|---|---|---|---|---|---|---|---|---|---|---|---|---|---|
| Ex. | 120 | 602 | 2254 | 6010 | 991 | 6210 | 6891 | 8402 | PEA | 256 | EHA | 506 | 351 | 502 | adhesion |
| C10 | 25 | | | | | | 25 | | 50 | | | | | | NG |
| C11 | 25 | | | | | 25 | | | 50 | | | | | | NG |
| C12 | 25 | | | | | | | 25 | 50 | | | | | | NG |
| C13 | 25 | | | | 25 | | | | 50 | | | | | | NG |
| C14 | 25 | | | 25 | | | | | 50 | | | | | | NG |
| C15 | 25 | | | | | | | 25 | 25 | 25 | | | | | NG |
| C16 | 25 | | | 25 | | | | | 25 | 25 | | | | | NG |
| C17 | 40 | | | 10 | | | | | 25 | 25 | | | | | NG |
| C18 | 25 | | 25 | | | | | | 25 | 25 | | | | | NG |
| C20 | 50 | | | | | | | | | 50 | | | | | NG |
| C21 | 30 | 30 | | | | | | | 30 | | | | | 10 | NG |
| C22 | 30 | 20 | | | | | | | 50 | | | | | | NG |
| C23 | 50 | | | | | | | | | | 30 | | | 20 | NG |
| C24 | 50 | | | | | | | | | 30 | | | | 20 | NG |
| C25 | 50 | | | | | | | | | | | 50 | | | NG |
| C26 | 50 | | | | | | | | 10 | | 40 | | | | NG |
| C27 | 50 | | | | | | | | 10 | 40 | | | | | NG |
| C28 | 50 | | | | | | | | 25 | 25 | | | | | NG |
| C29 | 42.5 | | | | | | | | 45 | | | | | 12.5 | NG |
| C30 | 25 | | 25 | | | | | | | | 30 | | | 20 | NG |
| C31 | 37.5 | | 17.5 | | | | | | | 45 | | | | | NG |
| C32 | 50 | | 10 | | | | | | | 40 | | | | | NG |
| C33 | 25 | | 25 | | | | | | | 30 | | | | 20 | NG |
| C34 | 17.5 | | 37.5 | | | | | | 45 | | | | | | NG |
| C35 | 17.5 | | 27.5 | | | | | | 55 | | | | | | NG |
| C36 | 25 | | 25 | | | | | | 50 | | | | | | NG |
| C37 | 27.5 | | 17.5 | | | | | | 55 | | | | | | NG |
| C38 | 37.5 | | 17.5 | | | | | | 45 | | | | | | NG |
| C39 | 25 | | 10 | | | | | | 45 | | | | 20 | | NG |
| C40 | 40 | | 2.5 | | | | | | 45 | | | | | 12.5 | NG |
| C41 | | 57.5 | | | | | | | 30 | | | | | 12.5 | NG |
| C42 | | 57.5 | | | | | | | 30 | | | | 12.5 | | NG |
| C43 | | 55 | 2.5 | | | | | | 30 | | | | | 12.5 | NG |
| C44 | | | 50 | | | | | | | 50 | | | | | NG |
| C45 | | | 50 | | | | | | | | 50 | | | | NG |
| C46 | | | 50 | | | | | | | | | 50 | | | NG |
| C47 | | | | 50 | | | | | | | | 50 | | | NG |
| C48 | | | | | 50 | | | | | | | 50 | | | NG |
| C49 | | | | | | 50 | | | | | | 50 | | | NG |
| C50 | | | | | | | 50 | | | | | 50 | | | NG |
| C51 | | | | | | | | 50 | | | | 50 | | | NG |
| C52 | | | | | 50 | | | | | 50 | | | | | NG |
| C53 | | | | | | | | 50 | | 50 | | | | | NG |

1) MOF skin layer was 100% PETg

What is claimed is:

1. An optical article comprising:
a multilayer optical film;
a light transmissive support layer; and
an adhesive layer disposed between the multilayer optical film and the light transmissive support layer, the adhesive layer comprising an aromatic polyester (meth)acrylate oligomer and an aromatic ethylenically unsaturated monomer, wherein
the total amount of the aromatic polyester (meth)acrylate oligomer and the aromatic ethylenically unsaturated monomer comprises at least about 90 wt. % of the adhesive layer.

2. The optical article of claim 1, the aromatic polyester (meth)acrylate oligomer comprising:
one or more dicarboxylic acids selected from the group consisting of naphthalene dicarboxylic acid; terephthalate dicarboxylic acid; phthalate dicarboxylic acid; isophthalate dicarboxylic acid; t-butyl isophthalic acid; tri-mellitic acid; 4,4′-biphenyl dicarboxylic acid; and combinations thereof.

3. The optical article of claim 1, the aromatic polyester (meth)acrylate oligomer comprising a pendant hydroxyl group.

4. The optical article of claim 1, the aromatic polyester (meth)acrylate oligomer comprising ring-opened bisphenol A diglycidal ether.

5. The optical article of claim 1, wherein the aromatic polyester (meth)acrylate oligomer is difunctional.

6. The optical article of claim 1, the aromatic ethylenically unsaturated monomer comprising one or monomers selected from the group consisting of: phenoxyethyl (meth)acrylate; phenoxy-2-methylethyl (meth)acrylate; phenoxyethoxyethyl (meth)acrylate; 3-phenoxy-2-hydroxypropyl (meth)acrylate; 2,4-dibromophenoxyethyl (meth)acrylate; 2,4,6-tribromophenoxyethyl (meth)acrylate; 4,6-dibromo-2-alkyl phenyl (meth)acrylate; 2,6-dibromo-4-alkyl phenyl (meth)acrylate; 2-(1-naphthyloxy)ethyl (meth)acrylate; 2-(2-naphthyloxy)ethyl (meth)acrylate; 2-(1-naphthylthio)ethyl (meth)acrylate; 2-(2-naphthylthio)ethyl (meth)acrylate; vinyl benzene; divinyl benzene; and combinations thereof.

7. The optical article of claim 1, the aromatic ethylenically unsaturated monomer comprising phenoxyethyl acrylate.

8. The optical article of claim 1, wherein the weight ratio of aromatic polyester (meth)acrylate oligomer to aromatic ethylenically unsaturated monomer is from about 30:70 to about 50:50.

9. The optical article of claim 1, the adhesive layer having a thickness of from about 5 to about 40 um.

10. The optical article of claim 1, the adhesive layer comprising tin in an amount of less than or equal to about 20 ppm.

11. The optical article of claim 1, the adhesive layer comprising tin in an amount of less than or equal to about 15 ppm.

12. The optical article of claim 1, the adhesive layer comprising a halide in an amount of less than or equal to about 300 ppm.

13. The optical article of claim 1, the multilayer optical film comprising a reflective film, a polarizer film, a reflective polarizer film, a diffuse blend reflective polarizer film, a diffuser film, a brightness enhancing film, a turning film, a mirror film, or a combination thereof.

14. The optical article of claim 1, the multilayer optical film comprising alternating layers of first and second optical layers, the first and second optical layers comprising first and second polymers, respectively, the first and second polymers selected from the group consisting of polyethylene terephthalate, polyethylene naphthalate, cellulose triacetate, polypropylene, polyester, polycarbonate, polymethylmethacrylate, polyimide, polyamide, and blends thereof.

15. The optical article of claim 1, the multilayer optical film having a thickness of about 50 um or less.

16. The optical article of claim 1, the light transmissive support layer comprising polyester or polycarbonate.

17. The optical article of claim 1, wherein the adhesive layer comprises less than 8.75 wt. % of an epoxy diacrylate.

18. A method of making an optical article, comprising:
applying a polymerizable adhesive composition between a multilayer optical film and a light transmissive support layer, the polymerizable adhesive composition comprising an aromatic polyester (meth)acrylate oligomer and an aromatic ethylenically unsaturated monomer; and
polymerizing the polymerizable adhesive composition to form an adhesive layer, wherein the adhesive layer adheres together the multilayer optical film and the light transmissive support layer, and
the total amount of the aromatic polyester (meth)acrylate oligomer and the aromatic ethylenically unsaturated monomer comprises at least about 90 wt. % of the adhesive layer.

19. The optical article formed by the method of claim 18.

20. An optical article comprising:
a multilayer optical film;
first and second support layers disposed on opposite sides of the multilayer optical film and adhered thereto by first and second adhesive layers, respectively, the first and second support layers being light transmissive, and the first and second adhesive layers consisting essentially of an aromatic polyester (meth)acrylate oligomer and an aromatic ethylenically unsaturated monomer.

21. A display device comprising:
a display panel,
one or more light sources, and
the optical article of claim 1.
